(19) United States
(12) Patent Application Publication
(10) Pub. No.: US 2021/0312257 A1
(43) Pub. Date: Oct. 7, 2021

(54) DISTRIBUTED NEUROMORPHIC INFRASTRUCTURE

(71) Applicant: Microsoft Technology Licensing, LLC, Redmond, WA (US)

(72) Inventor: Richard Scott Schilling, Seattle, WA (US)

(21) Appl. No.: 16/841,932

(22) Filed: Apr. 7, 2020

(51) Int. Cl. G06N 3/04; G06N 3/08

(52) U.S. Cl. CPC G06N 3/04; G06N 3/08

(57) ABSTRACT

In non-limiting examples of the present disclosure, systems, methods and devices for synchronizing neuromorphic models are presented. A sensor input may be received by a first neuromorphic model implemented on a neuromorphic architecture of a first computing device. The neuromorphic model may comprise a plurality of neurons, with each of the plurality of neurons associated with a threshold value, a weight value, and a refractory period value. The first sensor input may be processed by the first model. A first output value may be determined based on the processing. The model may be modified via modification of one or more threshold values, weight values, and/or refractory period values. A modified version of the first neuromorphic model may be saved to the first computing device based on the modification. An update comprising the modification may be sent to a second computing device hosting the model.

### BACKGROUND

Neuromorphic artificial intelligence (AI), also known as neuromorphic computing, is an approach to AI that mimics how mammal brains process information. The approach is characterized with less demands on power to perform similar tasks performed by other AI approaches (e.g., speech recognition), and in-situ training.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices for assisting with synchronizing neuromorphic models. Software and hardware based neuromorphic models trained to solve a particular task may be distributed across many devices and device types. For example, a single neuromorphic model may be trained in the cloud and distributed to various client devices. The training of such a neuromorphic model may be performed in the cloud utilizing a first dataset. Additional datapoints may be utilized to enhance the neuromorphic model. The datapoints may be generated by the client devices based on normal use of the neuromorphic model in the field. These new datapoints may be sent from the client devices to the cloud where there are more computing resources available. The new datapoints may be utilized to retrain the neuromorphic model, and the retrained neuromorphic model may be pushed back out to the client devices. In some examples, the training and retraining of the neuromorphic model may comprise application of a genetic algorithm to a dataset and a plurality of neuromorphic models.

Examples described herein embody one or more neuromorphic implementations in a mobile computing, desktop computing, cloud computing, and big data environments. Additional examples address scalability and infrastructure challenges of neuromorphic computing. Aspects described herein allow the user to address the classical “range versus precision” dilemma found in data processing where the user must make a tradeoff between processing a wide range of values or highly precise values. The present disclosure also provides an AI capability that is applied to both mobile devices and PCs in situations where mobile devices and PCs are tightly integrated.

### BRIEF DESCRIPTION OF THE DRAWINGS

Non-limiting and non-exhaustive examples are described with reference to the following figures:

FIG. 1 is a schematic diagram illustrating an example distributed computing environment for synchronizing neuromorphic models.

FIG. 2 illustrates a first exemplary neuromorphic model for processing image inputs.

FIG. 3 illustrates a modified version of the first neuromorphic model for processing image inputs after training.

FIG. 4 illustrates an exemplary neuromorphic model for processing soundwave inputs.

FIG. 5 illustrates the utilization of a host device in a multi-platform integrated device environment, for processing inputs from a remote device, with various neuromorphic engines.

FIG. 6 illustrates the training of a neuromorphic model on a new or updated dataset utilizing a genetic algorithm technique.

FIG. 7A is an exemplary method for synchronizing neuromorphic models.

FIG. 7B is another exemplary method for synchronizing neuromorphic models.

FIG. 8 is another exemplary method for synchronizing neuromorphic models.

FIGS. 9 and 10 are simplified diagrams of a mobile computing device with which aspects of the disclosure may be practiced.

FIG. 11 is a block diagram illustrating example physical components of a computing device with which aspects of the disclosure may be practiced.

FIG. 12 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The various embodiments and examples described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the claims.

A “neuromorphic model” as described herein is a spiking neuron model comprised of a plurality of neurons that are connected via synapses. Each neuron is associated with a threshold value, a weight value, and a refractory period value. A threshold value associated with a neuron is a charge value that must be met or exceeded via input synapses for the neuron to fire. A weight value associated with a neuron is a charge weight that is passed via firing of a first neuron to a second neuron via a connecting synapse. A refractory period value is a duration of time that a neuron may accumulate charge without firing. In neuromorphic models, there is an explicit time component, and rather than holding values, neurons hold charge. Synapses transmit charge over time, and when a synapse's charge arrives at a neuron, it is added to the neuron's charge value. If a neuron's charge exceeds a threshold, the neuron fires, resetting its charge value to some base value and sending charge out along its outgoing synapses. In a neuromorphic model, threshold values, weight values, and refractory period values are configurable. The goal of training a neuromorphic model is to define connections, thresholds, weights and delays so that the model can “solve” a task. With a classification task, the values of the datapoints must be converted into spikes, and output spikes must be converted into classifications.

A “host device” as described herein is a device that a user may control and/or view a copy, in real or near real-time, of a user interface of a “remote device”. A “remote device” as described herein is a device that may have its user interface copied, in real or near real-time, on a device mirroring application of a host device. The remote device may be controlled via the native controls of the host device via the device mirroring application.

Examples of the disclosure provide systems, methods, and devices for synchronizing neuromorphic models. A first version of a neuromorphic model that has been trained on a first dataset to solve a first task may be associated with a plurality of computing devices. The neuromorphic model may be software based or hardware based. In some examples, the neuromorphic model may be software based on some devices and hardware based on others. The neuromorphic model may have been trained to classify image data, audio data, and/or text data, for example. In some examples, the training of the first version of the neuromorphic model on the first dataset may comprise the application of a genetic algorithm to a plurality of generated neuromorphic models and the first dataset.

The first version of the neuromorphic model may be initially generated and/or trained in the cloud by a neuromorphic service and subsequently pushed out to one or more client devices (e.g., smart phones, tablets, laptops, various internet of things (IoT) devices) where the model can be implemented at the hardware and/or software level. As the client devices move data through the first version of the neuromorphic model, new data (e.g., new images, new audio, new text) that is not part of the first dataset may be processed and classified. In examples, the new data may be uploaded to the neuromorphic service and the first version of the neuromorphic model may be retrained utilizing an updated dataset that includes the new data. As with the initial training of the neuromorphic model, the retraining may comprise the application of a genetic algorithm to the first version of the neuromorphic model.

Once the neuromorphic model has been retrained utilizing the updated dataset, the updated neuromorphic model may be pushed out to one or more client devices that execute the now outdated first version of the neuromorphic model. Thus, the training of the neuromorphic model, which is processing intensive, may be performed in the cloud where there are plentiful processing resources, and the additional data that is added to the training datasets can be crowdsourced from many different client devices that are executing the neuromorphic models on diverse datasets.

The systems, methods, and devices described herein provide technical advantages for performing classification tasks. The mechanisms described herein significantly reduce processing costs associated classification tasks performed by other machine learning techniques (e.g., neural networks), while providing at least the same or similar fitness with comparable datasets. While the hardware based neuromorphic models described herein provided the greatest processing cost advantages, even the software based neuromorphic models provide orders of magnitude in processing savings. Furthermore, by allowing for the training of these neuromorphic models in the cloud and subsequent distribution of retrained models to client devices, the systems, methods, and devices described herein reduce the training of a neuromorphic model to a single instance, which can then be transferred and applied an unlimited number of times without the need to retrain the model at each client device.

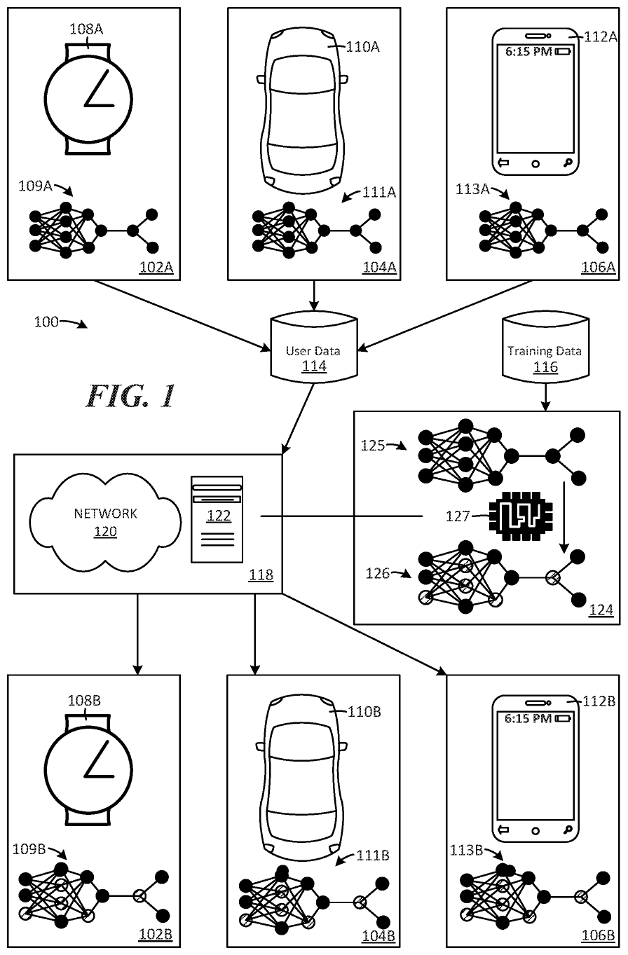

FIG. 1 is a schematic diagram illustrating an example distributed computing environment 100 for synchronizing neuromorphic models. Computing environment 100 includes network and processing sub-environment 118, cloud-based neuromorphic architecture 124, first IoT sub-environment 102A, second IoT sub-environment 104A, and third IoT sub-environment 106A. Computing environment 100 also includes modified first IoT sub-environment 102B, second modified IoT sub-environment 104B, and third modified IoT sub-environment 106B. The second IoT sub-environments include the same devices as in the first IoT sub-environments, but with modified/retrained neuromorphic models. Distributed computing environment 100 also includes user data 114 and training data 116.

First IoT sub-environment 102A includes smartwatch 108A and first neuromorphic model 109A. First neuromorphic model 109A comprises a plurality of spiking neurons connected by a plurality of synapses. The illustrated neurons and synapses of first neuromorphic model 109A are provided in their illustrated form for exemplary purposes and it should be understood that first neuromorphic model 109A may have more or fewer neurons, more or fewer synapses, and/or a different layout (e.g., different connections). Each neuron in first neuromorphic model 109A may be associated with a weight value, a threshold value, and a refractory period value. First neuromorphic model 109A may be implemented in a software architecture of smartwatch 108A or a hardware model of smartwatch 108A.

First neuromorphic model 109A may be trained to classify data and/or perform mathematical operations. For example, first neuromorphic model 109A may receive data from one or more sensors of smartwatch 108A, process that data through its network of neurons, and produce one or more output signals. The output signals, or lack thereof, may be converted into one or more classifications, solutions, and/or values by smartwatch 108A or an associated device. As an example, first neuromorphic model 109A may process heart rate and/or blood pressure signals from heart rate and/or blood pressure sensors integrated with smartwatch 108A and classify those signals into one or more potential health condition categories. In another example, first neuromorphic model 109A may process sound signals received by smartwatch 108A, determine whether the sound came from a user associated with smartwatch 108A, and/or classify the sound signals in one or more categories (e.g., irritated, calm, mad). In yet another example, first neuromorphic model 109A may process sound signals received by smartwatch 108A, classify those sound signals as words or word types, and/or classify one or more words or phrases into intent type categories.

Second IoT sub-environment 104A includes car 110A, which is integrated with a plurality of computing devices (e.g., microcontrollers), one or more of those computing devices may be associated with a neuromorphic model, such as second neuromorphic model 111A. Second neuromorphic model 111A comprises a plurality of spiking neurons connected by a plurality of synapses. The illustrated neurons and synapses of second neuromorphic model 111A are provided in their illustrated form for exemplary purposes and it should be understood that second neuromorphic model 111A may have more or fewer neurons, more or fewer synapses, and/or a different layout. Each neuron in second neuromorphic model 111A may be associated with a weight value, a threshold value, and a refractory period value. Second neuromorphic model 111A may be implemented in a software architecture of car 110A or a hardware model of car 110A.

Second neuromorphic model 111A may be trained to classify data and/or perform mathematical operations. For example, second neuromorphic model 111A may receive data from one or more sensors of car 110A, process that data through its network of neurons, and produce one or more output signals. The output signals, or lack thereof, may be converted into one or more classifications, solutions, and/or values by car 110A (e.g., one or more computers in car 110A) or an associated device. As an example, second neuromorphic model 111A may process image signals from one or more cameras integrated in car 110A and classify them as being in a lane or out of a lane, and/or too close to an object or outside of a threshold range of an object. In another example, second neuromorphic model 111A may process radar signals sent/received by car 110A and classify object distances as being above or below a threshold distance.

Third IoT sub-environment 106A includes smart phone 112A and third neuromorphic model 113A. Third neuromorphic model 113A comprises a plurality of spiking neurons connected by a plurality of synapses. The illustrated neurons and synapses of third neuromorphic model 113A are provided in their illustrated form for exemplary purposes and it should be understood that third neuromorphic model 113A may have more or fewer neurons, more or fewer synapses, and/or a different layout. Each neuron in third neuromorphic model 113A may be associated with a weight value, a threshold value, and a refractory period value. Third neuromorphic model 113A may be implemented in a software architecture of smart phone 112A or a hardware model of smart phone 112A.

Third neuromorphic model 113A may be trained to classify data and/or perform operations. For example, third neuromorphic model 113A may analyze sound and/or image data from smart phone 112A, process that data through its network of neurons, and produce one or more outputs. The output signals, or lack thereof, may be converted into one or more classifications, solutions, and/or values by smart phone 112A. As an example, third neuromorphic model 113A may process image signals from one or more images/videos received and/or saved to smart phone 112A and classify those images (e.g., identify person in image, identify object in image, identify specific person in image, etc.). In another example, third neuromorphic model 113A may process audio signals from smart phone 112A (or files or videos saved or streamed to smartphone 112A) and classify those signals (e.g., identify person from audio, classify words from audio, etc.).

Network and processing sub-environment 118 includes network 120 and server computing device 122. Any and all of the computing devices described herein may communicate with one another via a network, such as network 120. Server computing device 122 is illustrative of a computing device that may be utilized in a cloud-based infrastructure that may host a neuromorphic synchronization service. The neuromorphic synchronization service may reside a one or more server computing devices.

Cloud-based neuromorphic architecture 124 may be incorporated in the neuromorphic synchronization service. Cloud-based neuromorphic architecture 124 includes cloud-based neuromorphic model 125, modified cloud-based neuromorphic model 126, and neuromorphic hardware 127. That is, cloud-based neuromorphic architecture 124 illustrates that one or more neuromorphic models may reside and operate in hardware architecture of one or more computing devices in the cloud. In other examples, one or more neuromorphic models may reside and operate in software architecture of one or more computing devices in the cloud.

Cloud-based neuromorphic model 125 is illustrative of one or more of the neuromorphic models described above with regard to the IoT devices (e.g., first neuromorphic model 109A, second neuromorphic model 111A, third neuromorphic model 113A). In examples, because there are more computing resources in the cloud than at the individual IoT environment, a neuromorphic model that will be employed by multiple IoT devices may initially be generated and trained in the cloud (e.g., by the neuromorphic synchronization service). Once generated and trained, a neuromorphic model may then be sent to one or more IoT devices where it may operate in whole or in part. The neuromorphic model may be sent as software to the IoT devices. The neuromorphic model may then be saved as software or written to a neuromorphic hardware architecture on the IoT devices. In this example, the neuromorphic synchronization service generated and trained a first neuromorphic model and sent it to smart watch 108A, a second neuromorphic model and sent it to car 110A, and a third neuromorphic model and sent it to smart phone 112A. Those models, as originally trained, are first neuromorphic model 109A, second neuromorphic model 111A, and third neuromorphic model 113A.

The neuromorphic synchronization service may update its neuromorphic models based on modifications to its dataset. For example, cloud-based neuromorphic model 125 may have been trained on an original dataset comprising a plurality of datapoints. In this example, the original dataset is illustrated as training data 116. However, one or more of those datapoints may be updated/modified, one or more datapoints may be added to the original dataset, and/or one or more of the original datapoints may be deleted. When such modifications are made, or when a threshold number of modifications have been made to a dataset, the neuromorphic synchronization service may retrain a neuromorphic model, such as cloud-based neuromorphic model 125.

In examples, the modifications to the original dataset may be made based on data that is received from one or more remote devices that are executing the neuromorphic model (e.g., smartwatch 108A, car 110A, smart phone 112A). This new data is illustrated as user data 114. For example, if first neuromorphic model 109A is being utilized to process heart beat signals, and smartwatch 108A receives a new heart beat pattern, that pattern may be sent to the neuromorphic synchronization service where the corresponding model can be can be retrained in the cloud and subsequently sent back out to smartwatch 108A and other IoT devices hosting first neuromorphic model 109A. In another example, if second neuromorphic model 111A is being utilized to process image signals (e.g., lane line images) and an image of a new lane line color is received by car 110A and processed by second neuromorphic model 111A, that image may be sent to the neuromorphic synchronization service where the corresponding model can be retrained in the cloud and subsequently sent back out to car 110A and other IoT devices hosting second neuromorphic model 111A. In another example, if third neuromorphic model 113A is being utilized to classify words identified by smart phone 112A, and a new word is received by smart phone 112A, that word may be sent to the neuromorphic synchronization service where the corresponding model can be retrained in the cloud and subsequently sent back out to smart phone 112A and other IoT devices hosting third neuromorphic model 113A.

In this example, cloud-based neuromorphic model 125 is retrained via processing of user data 114, which results in modification of one or more weight values, threshold values, and/or refractory period values in cloud-based neuromorphic model 125. In additional examples, the connections of the neurons themselves may be modified based on the training/retraining process. The result is modified cloud-based neuromorphic model 126. Each of the modified models, or information indicating which modifications were made to the models, may be sent out to each of the IoT devices. Thus, smartwatch 108B now includes modified first neuromorphic model 109B in modified first IoT sub-environment 102B; car 110B now includes modified second neuromorphic model 111B in modified second IoT sub-environment 104B; and smart phone 112B now includes modified third neuromorphic model 113B in modified third IoT sub-environment 106B.

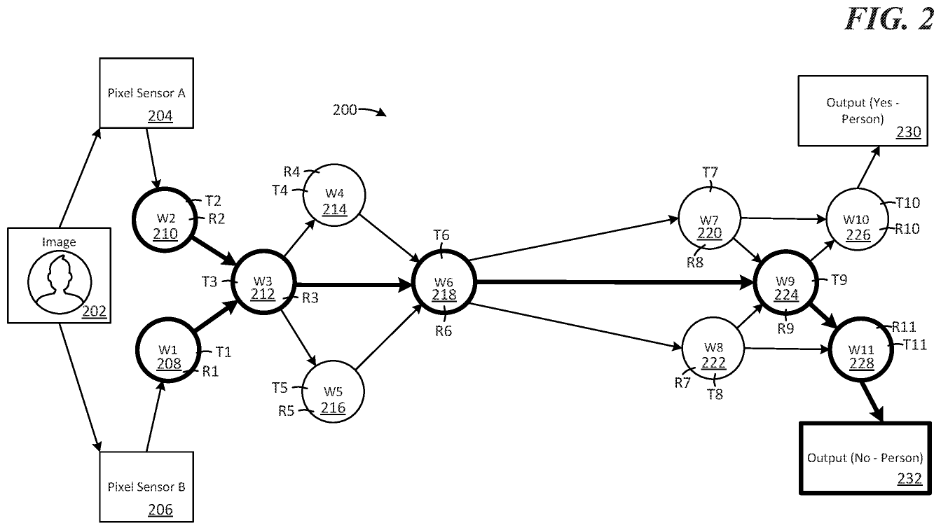

FIG. 2 illustrates a first exemplary neuromorphic model 200 for processing image inputs. Neuromorphic model 200 may be incorporated in a software architecture or hardware architecture. Neuromorphic model 200 may be hosted by one or more server computing devices and/or one or more IoT devices. Neuromorphic model 200 is simplified in that an image classification model would likely have hundreds, if not thousands, of pixel sensors. However, for ease of illustration neuromorphic model 200 includes two pixel sensors—pixel sensor A 204 and pixel sensor B 206.

Neuromorphic model 200 includes eleven neurons (neuron one 208, neuron two 210, neuron three 212, neuron four 214, neuron five 216, neuron six 218, neuron seven 220, neuron eight 222, neuron nine 224, neuron ten 226, and neuron eleven 228). Each of those neurons is associated with a weight value (W1 through W11), a threshold value (T1 through T11), and a refractory period value (R1 through R11). The weight values correspond to charge values of synapses that feed into each neuron. For example, neuron one 208 has a weight value corresponding to the charge that it can transfer to neuron three 212 via the connecting synapse. The threshold values correspond to a charge that a neuron must accumulate prior to firing. The refractory period values correspond to a duration of time where a neuron may accumulate charge without firing.

In this example, image 202 is analyzed by pixel sensor A 204 and pixel sensor B 206. Pixel sensor A 204 may analyze one or more pixels in a first location of image 202 and pixel sensor B 206 may analyze one or more pixels in a second location of image 202. Pixel sensor A 204 and pixel sensor B 206 may direct a charge to the root neurons of neuromorphic model 200. That is, pixel sensor A 204 may direct a charge to neuron two 210, and pixel sensor B 206 may direct a charge to neuron one 208. The charge that those sensors may direct to their respective neurons may be an all or nothing charge, or the charge may be variable based on the pixel input. For example, if a pixel is over a certain darkness or within a certain color palate, a sensor may fire. If a pixel is under a certain darkness or outside a certain color palate, a sensor may not fire. Alternatively, the amount of charge that is fired by a sensor may vary based on the darkness and/or color corresponding to a pixel.

According to some examples, one or more preprocessing operations may be performed on an image that is being analyzed prior to that data being provided to neuromorphic model 200. For example, there may be one or more pre-processors between image 202 and/or pixel sensor A 204, and neuron two 210. Similarly, there may be one or more pre-processors between image 202 and/or pixel sensor B 206, and neuron one 208. The one or more pre-processors may perform one or more image filtering operations and/or one or more image augmentation operations. Examples of image pre-processing that may be performed include resizing images, removing noise (e.g., blurring an image with a Gaussian function), segmenting an image, separating background from foreground objects, and applying custom filters. Additionally, data from the sensors themselves may be processed prior to being received by neuromorphic model 200.

Pixel sensor A 204 fires and a charge is directed to neuron two 210. That charge is above threshold T2, and as such, neuron two 210 fires. The charge fired by neuron two 210 is directed via synapse to neuron three 212.

Pixel sensor B 206 fires a charge directed to neuron one 208. That charge is above threshold T1, and as such, neuron one 208 fires. The charge fired by neuron one 208 is directed via synapse to neuron three 212.

Based on the charges received via neuron one 208 and neuron two 210, the charge of neuron three exceeds threshold T3, which causes neuron three 212 to fire. In this example, the threshold values for neuron four 214 (T4) and neuron five 216 (T5) are greater than the charge amount fired by neuron three 212. As such, they do not fire. However, the charge fired by neuron three 212 is above threshold T6 for neuron six 218. As such, neuron six 218 fires.

The threshold values for neuron eight 222 (T8) and neuron seven 220 (T7) are greater than the charge amount fired by neuron six 218. As such, they do not fire. However, the charge fired by neuron six 218 is above threshold T9 for neuron nine 224. As such, neuron nine 224 fires.

The threshold value for neuron ten 226 (T10) is greater than the charge amount fired by neuron nine 224. As such, neuron ten 226 does not fire. However, the charge fired by neuron nine 224 is above threshold T11 for neuron eleven 228. As such, neuron eleven 228 fires. The charge from the firing of neuron eleven 228 may be analyzed and a subsequent classification of image 202 as not being or including an image of a person may be made as indicated by element 232.

According to some examples, one or more post-processing operations may be performed on data from neuromorphic model 200. Examples of post-processing operations may include data filtering operations and histogram generation operations.

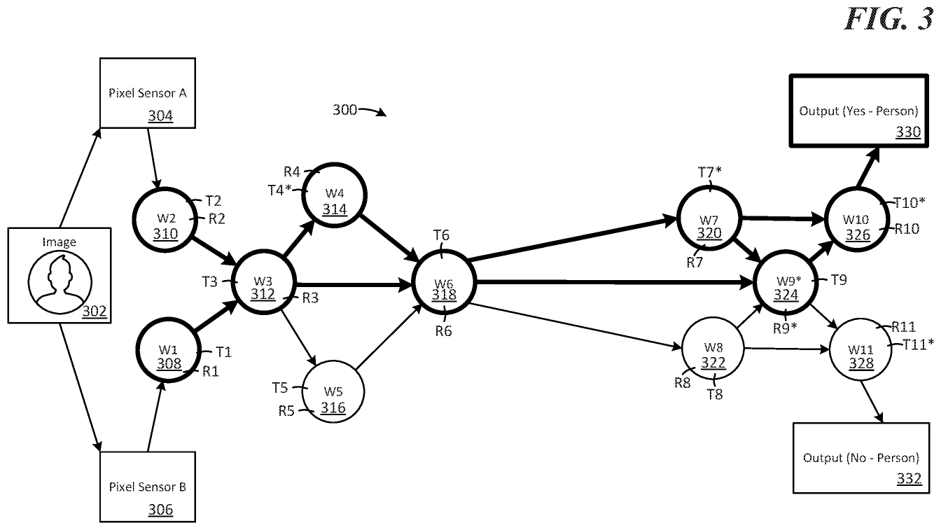

FIG. 3 illustrates a modified version 300 of the first neuromorphic model 200 for processing image inputs after training. That is, it was determined that the classification of image 202 as not including/being a person was incorrect, as such first neuromorphic model 200 was trained/retrained via one or more mechanisms, resulting in modified version 300 of first neuromorphic model 200. In some examples, feedback may have been provided to the model that the classification of image 202 was incorrect and first neuromorphic model 200 may automatically be reconfigured. The reconfiguring/training may comprise modifying one or more: weight values, threshold values, and/or refractory period values of neuromorphic model 200. In other examples, the reconfiguring/training may comprise feeding first neuromorphic model 200 additional images and providing positive or negative feedback to neuromorphic model 200 based on its classification of those images. Any of the neuromorphic models described herein may include one or more feedback loops as described above.

Modified version 300 of first neuromorphic model 200 includes eleven neurons (neuron one 308, neuron two 310, neuron three 312, neuron four 314, neuron five 316, neuron six 318, neuron seven 320, neuron eight 322, neuron nine 324, neuron ten 326, and neuron eleven 328). Each of those neurons is associated with a weight value (W1 through W11), a threshold value (T1 through T11), and a refractory period value (R1 through R11). The weight values correspond to charge values of synapses that feed into each neuron. For example, neuron one 308 has a weight value corresponding to the charge that it can transfer to neuron three 312 via the connecting synapse. The threshold values correspond to a charge that a neuron must accumulate prior to firing. The refractory period values correspond to a duration of time where a neuron may accumulate charge without firing.

Based on the training that occurred, the threshold T4* for neuron four 314 has been reduced, the threshold T7* for neuron seven 320 has been reduced, the weight W9* associated with neuron nine 324 has been increased, the threshold T10* for neuron ten 326 has been reduced, the threshold T11* for neuron eleven 328 has been increased, and the refractory period value R9* for neuron nine 324 has been increased. Thus, while the charges from pixel sensor A 304 and pixel sensor B 306 remain the same for processing of image 302 as they were for image 202, a different pathway in the neuromorphic model is taken and a different result (Yes—Person) is accomplished.

Pixel sensor A 304 fires a charge that is received by neuron two 310. The charge received by neuron two 310 is above threshold T2, which causes neuron two 310 to fire and direct a charge to neuron three 312 via a synapse.

Pixel sensor B 306 fires a charge that is received by neuron one 308. The charge received by neuron one 308 is above threshold T1, which causes neuron one 308 to fire and direct a charge to neuron three 312 via a synapse.

The combined charge from neuron one 308 and neuron two 310 is above threshold T3 for neuron three 312. As such, neuron three 312 fires a charge directed to neuron four 314 and neuron six 318. The charge from the firing of neuron three 312 is above the new threshold T4* for neuron four 314. As such, neuron four 314 fires and directs a charge to neuron six 318 via a synapse.

The combined charge from neuron four 314 and neuron 312 is above threshold T6 for neuron six 318. As such, neuron six 318 fires. The charge fired from neuron six 318 is above new threshold T7* for neuron seven 320 and, and above threshold T9 for neuron nine 324. With the refractory period R9* for neuron nine 324 increased, neuron nine 324 maintains the charge from the firing of neuron six 318 until the charge from neuron seven 320 reaches it. The combined charges from neuron six 318 and neuron seven 320 exceed threshold T9 for neuron nine 324 causing it to fire.

The charge from the firing of neuron nine 324 is received by neuron ten 326, which also receives charge from the firing of neuron seven 320. The combined charge from the firing of neuron seven 320 and neuron nine 324 exceeds new reduced threshold T10* for neuron ten 326. Neuron ten 326 thus fires. The charge from the firing of neuron ten 326 may be analyzed and a subsequent classification of image 302 as being or including an image of a person may be made as indicated by element 330.

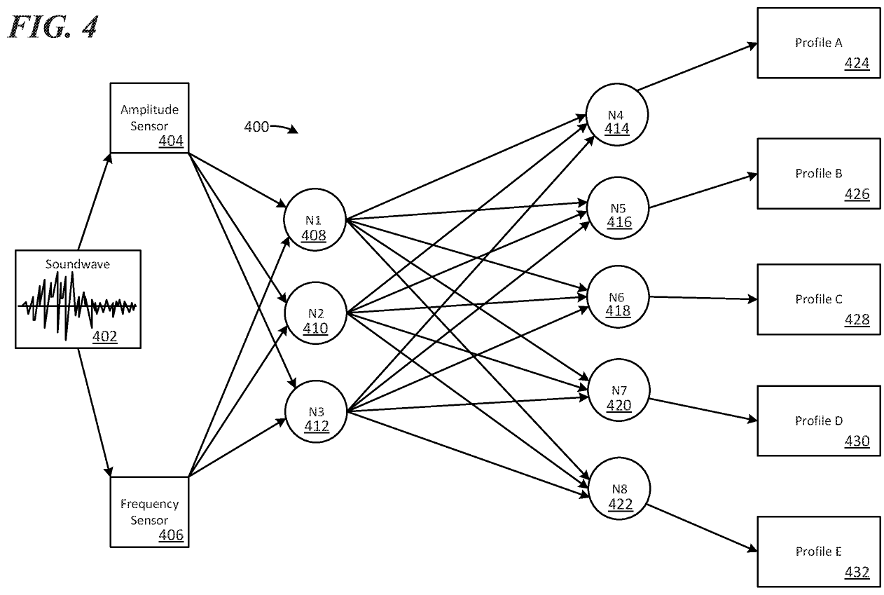

FIG. 4 illustrates an exemplary neuromorphic model 400 for processing soundwave inputs. Neuromorphic model 400 may be a software model or a hardware model. Neuromorphic model 400 may be incorporated in a client device (e.g., a smart phone, a tablet, a laptop) and/or neuromorphic model 400 may be hosted in the cloud and receive data from one or more client devices. Neuromorphic model 400 has been trained to categorize sound waves into user profile categories. That is, neuromorphic model 400 has been trained to match sound input to one of a plurality of user profiles that have been built based on previously received and processed sound inputs.

Neuromorphic model 400 includes a plurality of integrated spiking neurons (N1-N8). Although not shown, each of the plurality of spiking neurons is associated with a threshold value, a weight value, and a refractory period value. Sensors that receive soundwave 402 provide signals to a first layer of neurons, the first layer of neurons feed into a second layer of neurons, and the second layer of neurons feed into an output layer comprised of a plurality of user profiles. In some examples, a user profile associated with a neuron that fires first may be identified as a matching user profile. In other examples, a user profile associated with a neuron that fires the most during a period of time may be identified as a matching user profile. In another example, a user profile associated with a neuron that does not fire may be identified as a matching user profile.

Soundwave 402 may be received via a microphone on a client device and transmitted to amplitude sensor 404 and frequency sensor 406. Amplitude sensor 404 provides a signal to each of neurons N1 408, N2 410, and N3 412. If the threshold value for one or more of N1 408, N2 410, and/or N3 412 is exceeded, the corresponding neuron may fire and transmit charge to neurons N4 414, N5 416, N6 418, N7 420, and N8 422. If a threshold value for one or more of those neurons is exceeded, the corresponding neuron may fire and transmit charge that can be converted into a signal related to a corresponding one of profile A 424, profile B 426, profile C 428, profile D 430, and/or profile E 432. As such, a determination may be made as to whether and which user profile matches soundwave 402.

According to some examples, one or more preprocessing operations may be performed on sound data that is being analyzed prior to that data being provided to neuromorphic model 400. For example, there may be one or more pre-processors between soundwave 402 and/or amplitude sensor 404, and N1 408. Similarly, there may be one or more pre-processors between soundwave 402 and/or frequency sensor 406, and N3 412. The one or more pre-processors may perform one or more sound filtering operations and/or one or more sound augmentation operations. Examples of sound pre-processing operations that may be performed include compression operations, Fast Fourier transforms operations, equalization operations, and application of custom filters. Additionally, data from the sensors themselves may be processed prior to being received by neuromorphic model 400.

Neuromorphic model 400 may be retrained as additional sound files are received for users associated with one or more of the user profiles. For example, if a soundwave file for a user associated with profile A 424 is received via a smart phone, that file may be uploaded to the cloud where neuromorphic model 400 may be retrained on that file. Once retrained, the updated model may be pushed out to one or more client devices (e.g., back out to the smart phone, to other devices associated with profile A 424).

According to some examples, one or more post-processing operations may be performed on data from neuromorphic model 400. Examples of post-processing operations may include filtering operations, and histogram generation operations.

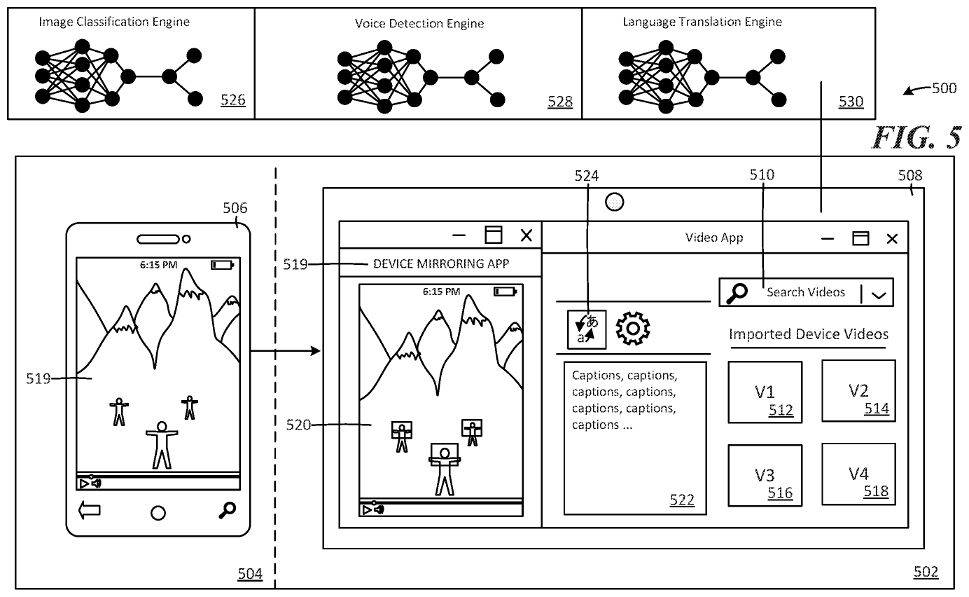

FIG. 5 illustrates the utilization of a host computing device 508 in a multi-platform integrated device environment 500, for processing inputs from a remote computing device 506, with various neuromorphic engines. Integrated device environment 500 incudes host computing device sub-environment 502, which includes host computing device 508, and remote computing device sub-environment 504, which includes remote computing device 506. Integrated device environment 500 also includes image classification engine 526, voice detection engine 528, and language translation engine 530.

Host computing device 508 is running device mirroring application 519. Device mirroring application 519 may be utilized to connect with one or more other computing devices (e.g., remote computing device 506) that operate on a same or different platform as host computing device 508, and mirror one or more of the features being executed and/or displayed by the connected computing devices. In some examples, device mirroring application 519 may be launched and/or connected to another computing device that it has been granted access to when a user specifically opens/starts device mirroring application 519 from host computing device 518. In other examples, device mirroring application 519 may be launched and/or connected to another computing device based on an interaction with a notification received by remote computing device 516, and subsequently received by host computing device 508. For example, a user may setup a feature where application notifications from the user's smart phone (e.g., remote computing device 516) are received by one or more of the user's other devices (e.g., host computing device 508). Thus, in a specific example, a text message notification from remote computing device 506 may also be received by host computing device 508, a user may interact with the notification on host computing device 508 and thereby automatically cause device mirroring application 519 to launch, with the device mirroring application user interface displaying a mirrored display of what the same interaction would produce if the user interacted with the notification on remote computing device 506.

Host computing device 508 and remote computing device 506 may connect and communicate with one another for device mirroring application purposes via various network types. In this example, host computing device 508 and remote computing device 506 are illustrated as communicating via Bluetooth connection. Host computing device 508 and remote computing device 506 may communicate with one another via alternative means (e.g., if the devices are not within Bluetooth range), such as via the Internet, a local area connection, a WiFi connection, etc.

In some examples, once a connection has been established between host computing device 508 and remote computing device 506, the image, audio, and video data from remote computing device 506 may be mirrored by device mirroring application 519 on host computing device 508. Additionally, remote computing device 506 may send event metadata to host computing device 508. The event metadata may include metadata generated by and/or associated with remote computing device 506's operating system and/or metadata generated by and/or associated with applications executed by remote computing device 506. In examples, the event metadata may comprise one or more of: structural metadata, descriptive metadata, process metadata, descriptive metadata, and/or accessibility metadata. For example, the mirroring application executed on host computing device 508 may subscribe and/or be provided with access to (in real or near real-time) all or a set of metadata generated by the operating system and/or applications of remote computing device 506.

In this example, image classification engine 526, voice detection engine 528, and language translation engine 530 reside on host computing device 508. However, one or more of those engines may additionally or alternatively reside on remote computing device 506. Image classification engine 526 comprises a neuromorphic model, comprising a plurality of integrated spiking neurons, that has been trained to classify images. Specifically, image classification engine 526 has been trained to identify portions of images/videos that contain persons. Voice detection engine 528 comprises a neuromorphic model, comprising a plurality of integrated spiking neurons, that has been trained to identify portions of audio that contain speech. In some examples, voice detection engine 528 may have been trained to identify a specific user from a plurality of voices that are analyzed. Language translation engine 530 comprises a neuromorphic model, comprising a plurality of integrated spiking neurons, that has been trained to classify words and/or phrases received in a first language into one or more classifications (e.g., vectors) in one or more additional languages.

Video 519 is being played on remote computing device 506. As such, that video is also being mirrored and played in device mirroring application 519, as indicated by mirrored video 520 on host computing device 508. According to examples, when host computing device 508 receives content, such as mirrored video 520, from a remote computing device, it may analyze that content with one or more neuromorphic models. In this example, host computing device 508 analyzes that content (the video and corresponding audio) with image classification engine 526, voice detection engine 528, and language translation engine 530.

A neuromorphic model associated with image classification engine 526 may determine whether one or more frames of mirrored video 520 include images of persons. In this example, a positive determination has been made that mirrored video 520 includes images of persons. As such, an indication is displayed in association with the identified persons in the video. In this case, the indication is a box surrounding the persons' faces. In some examples, metadata indicating that a video, or frames in a video, have an identified object (e.g., a person) in it may be associated with an analyzed video. The metadata may be utilized for searching purposes (e.g., a user may query one or more videos for object types). For example, a user may type a search for “people” into “search videos” element 510 on host computing device 508, which may cause a query for “people” and/or a synonym such as “persons” to be made against one or more videos that have been imported. In this example, that search is run against “Imported Device Videos” and specifically video one 512, video two 514, video three 516, and video four 518. In additional examples, the metadata may be utilized to enhance accessibility features, such as captions that may be displayed for persons that have sight impairments. Thus, it may be indicated in captions element 522 that persons are present on mirrored video 520 when it is being played in addition to captions corresponding to speech that is included in the video. The captions may be narrated by an accessibility engine. The objects that may be identified via image classification engine 526 and the associated neuromorphic model are not limited to persons. For example, a neuromorphic model may be trained to identify and tag mountains, trees, animals, types of animals, locations, sports, and other objects.

A neuromorphic model associated with voice detection engine 528 may be trained to identify portions of audio from content (e.g., from mirrored video 520) that contain speech. In additional examples, voice detection engine 528 and/or a neuromorphic model associated with voice detection engine 528 may be trained to identify a specific user from a plurality of voices in audio from content. Once speech has been identified in audio associated with content, metadata may be associated with that content that indicates what portion of the content the speech occurred (at minute 1 of an audio recording, at time 2:37 of a video, etc.). That metadata may be utilized for searching the content and/or for accessibility purposes. In examples where a specific user is identified from speech in content, the content may be tagged with metadata indicating the identity of that specific person. Thus, a query for content that includes speech and/or speech from specific persons may be made and completed based on the metadata tagging that was performed via utilization of voice detection engine 528. For example, a drop-down menu included in “search videos” element 510 may be utilized that allows a user to search by metadata type (e.g., speech, image, etc.). If a selection is made of the speech metadata type, a user may search for “[person A]” and any videos under “imported device videos” that contain speech that has been tagged as being from [person A] may be surfaced as query results. In some examples, there may be indicators in those videos corresponding to the times when [person A] is speaking.

A neuromorphic model associated with language translation engine 530 may classify words and/or phrases received in a first language into one or more classifications in one or more additional languages. Thus, if new words or phrases that are not already part of a translation corpus are received from content, they may be added to the corpus based on their classification by a neuromorphic model associated with language translation engine 530. As such, if an interaction is received in relation to translation element 524, the captions for mirrored video 520 in captions element 522 may be translated to one or more secondary languages in an accurate manner that takes into account new words and phrases that are not already built into a translation corpus. Additionally, as a translation corpus is expanded, the metadata that is associated with content received from remote computing device 506 may be enhanced to include additional tags from additional languages. Thus, the searching and accessibility features described above may be further expanded for the use by users that are native in different languages.

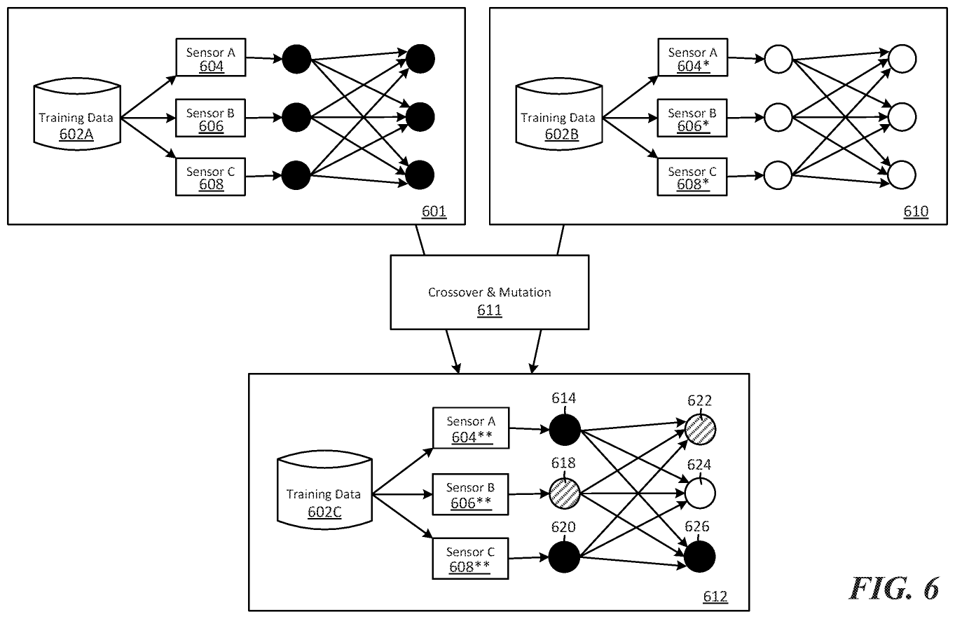

FIG. 6 illustrates the training of a neuromorphic model on a new or updated dataset utilizing a genetic algorithm technique. FIG. 6 includes original neuromorphic model A 601, original neuromorphic model B 610, and modified neuromorphic model 612. Although only two original neuromorphic models are shown for ease of illustration, it should be understood that additional original models may be generated and utilized in applying a genetic algorithm to train neuromorphic models.

In utilizing a genetic algorithm to train neuromorphic models, an initial population of networks may be generated randomly. These models are original neuromorphic model A 601 and original neuromorphic model B 610. Heuristics may be employed to intelligently initialize neuromorphic networks, for example, to force input neurons to have paths to output neurons.

Next, each network in the population may be evaluated and given a fitness value. This may be done having an application apply a training suite of tasks to it (e.g., sweeping through a training set of data) and measure its success (e.g., calculating the accuracy of the classification). In this example, original neuromorphic model A 601 is applied to training data set 602A, and original neuromorphic model B 610 is applied to training data set 602B. Training data sets 602A, 602B, and 602C are the same set of datapoints. Additionally, sensor A 604 is the same sensor as sensor A 604* and sensor 604**; sensor B 606 is the same sensor as sensor B 606* and sensor 606**; and sensor C 608 is the same sensor as sensor C 608* and sensor 608**.

Once the population has been evaluated based on the fitness values determined based on application of the neuromorphic models to training data, the members of the population with the highest fitness may be selected for reproduction, which may involve mutating parameters of single networks, and performing crossover operations on pairs of networks. This is illustrated by crossover and mutation element 611. Specifically, one or more connections, weight values, threshold values, and/or refractory period values for the neuromorphic models with the highest fitness may be picked out and combined into a new model, and one or more connections, weight values, threshold values, and/or refractory period values from those original models may be mutated in generating the new model. In this example, new neuromorphic model 612 is generated based on the crossover and mutation of original neuromorphic model A 601 and original neuromorphic model B 610.

In this example, neurons 614, 620 and 626, including their associated weight values, threshold values, and refractory period values have been replicated in new neuromorphic model 612 from original neuromorphic model A 601. Neuron 624, including its associated weight value, threshold value, and refractory period value, has been replicated in new neuromorphic model 624, and one or more values have been mutated from original neuromorphic A 601 or original neuromorphic model B 610 for each of neuron 618 and neuron 622 in new neuromorphic model 612.

Although only a single progeny model (new neuromorphic model 612) is illustrated in this example, it should be understood that a plurality of progeny models may be generated from a plurality of original models. Each of the progeny models may thus be applied to the training data set (e.g., training data set 602C), and the process described above may be repeated until fitness achieves a desired threshold, or after a specified period of time has passed.

Once trained to a specified fitness threshold, the trained neuromorphic model may be pushed out to one or more devices. For example, if the genetic algorithm is applied to generate a model in the cloud, the that model may be pushed out to one or more client devices upon the fitness threshold being met.

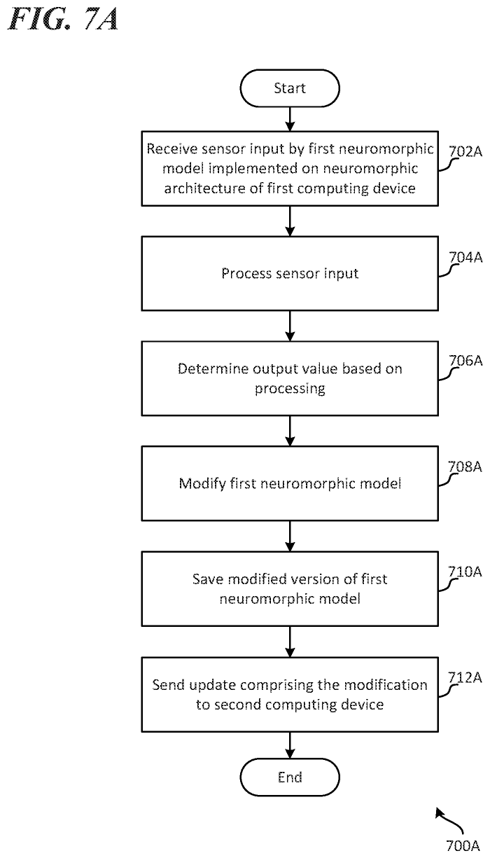

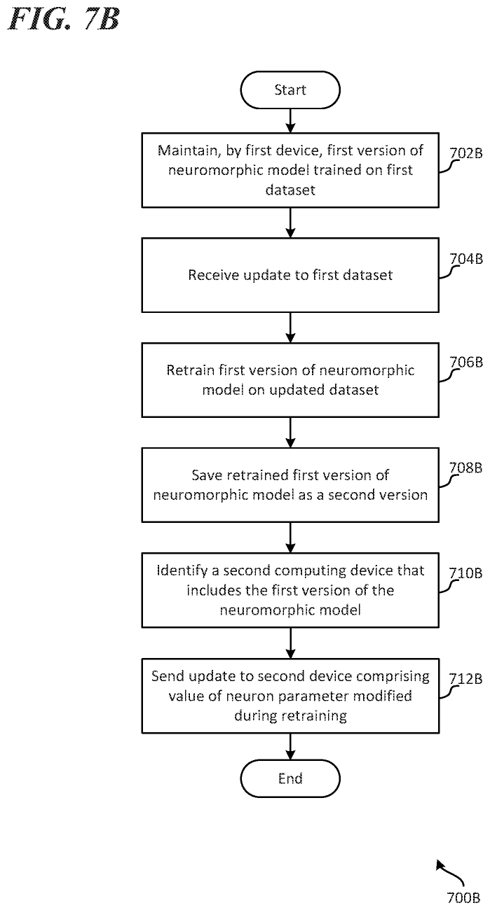

FIG. 7A is an exemplary method 700A for synchronizing neuromorphic models. The method 700A begins at a start operation and flow moves to operation 702A.

At operation 702A a sensor input is received by a first neuromorphic model implemented on a neuromorphic architecture of a first computing device. The first computing device may be a server computing device (e.g., the cloud hosts the first neuromorphic model), or the first computing device may be a client computing device (e.g., a smart phone, a laptop, a tablet). The neuromorphic model comprises a plurality of neurons, and each of the plurality of neurons is associated with a threshold value, a weight value, and a refractory period value. A threshold value associated with a neuron is a charge value that must be met or exceeded via input synapses for the neuron to fire. A weight value associated with a neuron is a charge weight that is passed via firing of a first neuron to a second neuron via a connecting synapse. A refractory period value is a duration of time that a neuron may accumulate charge without firing. The neuromorphic architecture of the first neuromorphic model may be software or hardware based. The input may comprise a signal generated from an image (e.g., a pixel or group of pixels) file, a video file, a sound file, and/or a text file, for example. In some examples, a file may be converted into a secondary file type that the input may then be received by the neuromorphic model in (e.g., a sound file may be converted to an image file).

From operation 702A flow continues to operation 704A where the first sensor input is processed by the first neuromorphic model. The first neuromorphic model may have previously been trained to process inputs of the input type. For example, the first neuromorphic model may have been trained to categorize inputs of the input type into one or more categories. The processing of the input by the first neuromorphic model may comprise providing the input to a first layer of neurons in the first neuromorphic model, where it may be passed via neuron spiking to one or more hidden layers of the first neuromorphic model, and finally to an output layer of the first neuromorphic model.

From operation 704A flow continues to operation 706A where a first output value is determined based on the processing of the first sensor input. In some examples, the first output value may be classified via binary classification (e.g., all or nothing). For example, a first value (e.g., 1) may be determined if a first neuron of the output layer of the first neuromorphic model fires, and a second value (e.g., 0) may be determined if the first neuron of the output layer of the first neuromorphic does not fire. In another example, the first output value may be classified in a variable manner. For example, the first output value may have a higher value associated with it based on a higher firing rate of a neuron in the output layer of the first neuromorphic model, and the first output value may have a lower value associated with it based on a lower firing rate of a neuron in the output layer of the first neuromorphic model.

From operation 706A flow continues to operation 708A where one of: a threshold value of a neuron in the first neuromorphic model, a weight value of the neuron in the first neuromorphic model, and a refractory period value of the neuron in the first neuromorphic model is modified. Any of those values may be increased or decreased. For example, lowering a threshold value of a neuron may result in increased firing of that neuron for a same dataset. Alternatively, increasing a threshold value of a neuron may result in a decreased firing of that neuron for a same dataset. Decreasing a weight value of a neuron may result in decreased firing of a downstream neuron for a same dataset, while increasing a weight value of may result in increased firing of a downstream neuron for a same dataset. Decreasing a refractory period value of a neuron may result in decreasing the firing of that neuron and one or more downstream neurons in a same dataset and increasing a refractory period value of a neuron may result in increasing the firing of that neuron and one or more downstream neurons in a same dataset.

From operation 708A flow continues to operation 710A where a modified version of the first neuromorphic model is saved to the first computing device based on the modification. That is, the neuromorphic model with the modifications to one or more of a weight value, a threshold value, and/or a refractory period value of a neuron may be saved to the first computing device.

From operation 710A flow continues to operation 712A where an update comprising the modification is sent to a second computing device hosting the first neuromorphic model. For example, if the first computing device is a client computing device, the modified neuromorphic model or just the updates corresponding to the modifications to the first neuromorphic model may be sent to one or more computing devices in the cloud that host the first neuromorphic model. Alternatively, if the first computing device is a cloud computing device, the modified neuromorphic model or just the updates corresponding to the modifications to the first neuromorphic model may be sent to one or more client computing devices on which the first neuromorphic model resides.

From operation 712A flow moves to an end operation and the method 700A ends.

FIG. 7B is another exemplary method 700B for synchronizing neuromorphic models. The method 700B begins at a start operation and flow moves to operation 702B.

At operation 702B a first version of a neuromorphic model that has been trained on a first dataset is maintained by a first computing device. The first version of the neuromorphic model comprises a plurality of neurons and each of the plurality of neurons is associated with a plurality of parameters. The plurality of parameters comprises a threshold value, a weight value, and a refractory period value. The first computing device may be a server computing device (e.g., the cloud hosts the neuromorphic model), or the first computing device may be a client computing device (e.g., a smart phone, a laptop, a tablet). A threshold value associated with a neuron is a charge value that must be met or exceeded via input synapses for the neuron to fire. A weight value associated with a neuron is a charge weight that is passed via firing of a first neuron to a second neuron via a connecting synapse. A refractory period value is a duration of time that a neuron may accumulate charge without firing. The neuromorphic architecture of the neuromorphic model may be software or hardware based. The neuromorphic model may have been trained to classify files of a particular type (e.g., image, video, sound, text, etc.). Thus, the first dataset may comprise a plurality of images, a plurality of videos, a plurality of sounds, or a plurality of letters, numbers, words, phrases, strings, and/or sentences.

From operation 702B flow continues to operation 704B where an update to the first dataset is received. The update may comprise one or more additional datapoints (e.g., additional images, additional videos, additional sounds, additional letters, additional numbers, additional words, additional phrases, additional strings, additional sentences). The update may be received via user input. For example, if the neuromorphic model is associated with a user account and that user account is associated with a client device that receives a new image, that image may be added to an image dataset (if the neuromorphic model has been trained to classify images). As another example, if the neuromorphic model is associated with a user account and the user account is associated with a client device that receives a new audio file, that image may be added to a sound dataset (if the neuromorphic model has been trained to classify sound). In an example where the first computing device is a cloud-based computing device, the update may be sent to the cloud-based computing device from a client computing device where the update (e.g., the new content) was initially received.

From operation 704B flow continues to operation 706B where the first version of the neuromorphic model is retrained on the updated dataset. The retraining comprises modifying a value of one of the parameters of the first version of the neuromorphic model. Although a single parameter may be modified for a single neuron, a plurality of parameters for a neuron may additionally be modified. In other examples, one or more parameters for a plurality of neurons may be modified. In some examples, the retraining may comprise applying a genetic algorithm to the first version of the neuromorphic model and one or more additional neuromorphic models that have been trained on the original dataset and/or the updated dataset.

From operation 706B flow continues to operation 708B where a second computing device that includes the first version of the neuromorphic model is identified. For example, if the first computing device is a server computing device (e.g., a cloud-based computing device that hosts the neuromorphic model), the second computing device may be a client computing device that includes the first version of the neuromorphic model. That is, there may be a cloud-based version of the neuromorphic model, which is then updated based on the retraining on the updated dataset, and there may be one or more additional devices that are associated with the cloud service that can receive updates to their neuromorphic models based on the retraining.

From operation 708B flow continues to operation 710B where an update comprising the modified value of one of the parameters is sent to the second computing device. The update may comprise the entirety of the retrained neuromorphic model or the update may comprise only the differences between the first version of the neuromorphic model and the retrained neuromorphic model.

From operation 710B flow moves to an end operation and the method 700B ends.

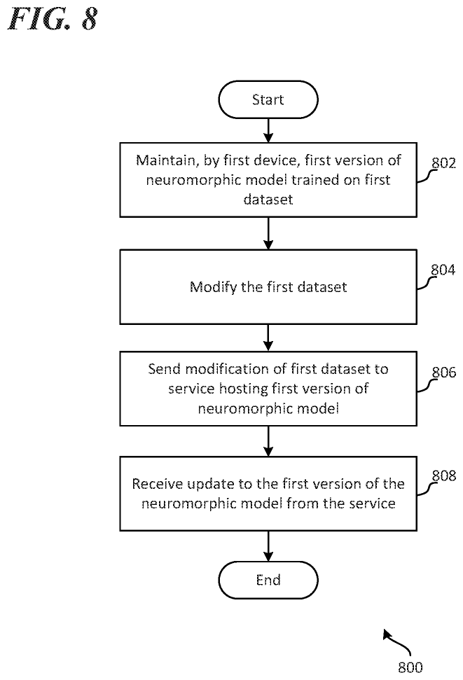

FIG. 8 is another exemplary method 800 for synchronizing neuromorphic models. The method 800 begins at a start operation and flow moves to operation 802.

At operation 802 a first version of a neuromorphic model that has been trained on a first dataset is maintained by a first computing device. The first version of the neuromorphic model comprises a plurality of neurons and each of the plurality of neurons is associated with a plurality of parameters. The plurality of parameters comprises a threshold value, a weight value, and a refractory period value. The first computing device may be a client computing device (e.g., a smart phone, a laptop, a tablet) that is associated with a user account linked to a cloud-based neuromorphic service. A threshold value associated with a neuron is a charge value that must be met or exceeded via input synapses for the neuron to fire. A weight value associated with a neuron is a charge weight that is passed via firing of a first neuron to a second neuron via a connecting synapse. A refractory period value is a duration of time that a neuron may accumulate charge without firing. The neuromorphic architecture of the neuromorphic model may be software or hardware based. The neuromorphic model may have been trained to classify files of a particular type (e.g., image, video, sound, text, etc.). Thus, the first dataset may comprise a plurality of images, a plurality of videos, a plurality of sounds, or a plurality of letters, numbers, words, phrases, strings, and/or sentences.

From operation 802 flow continues to operation 804 where the first dataset is modified. The update may comprise adding a datapoint (e.g., an image, an audio file, a text file, a word, etc.) to the first dataset, removing a datapoint from the first dataset, and/or modifying a datapoint of the first dataset.

From operation 804 flow continues to operation 806 where the modification of the first dataset is sent to a service hosting the first version of the neuromorphic model in a cloud-based infrastructure. The modification may be sent to the service from a client device associated with the service and/or a client device associated with the neuromorphic model. In other examples, the modification may be input by a developer that is making changes to the neuromorphic model.

From operation 806 flow continues to operation 808 where an update to the first version of the neuromorphic model is received from the service. The update to the first version of the neuromorphic model may be received by one or more client devices that host the first version of the neuromorphic model. The update may comprise a retrained version of the neuromorphic model based on the modified dataset. In other examples, the update may comprise the differences between the first version of the neuromorphic model and the retrained version of the neuromorphic model based on the modified dataset.

From operation 808 flow moves to an end operation and the method 800 ends.

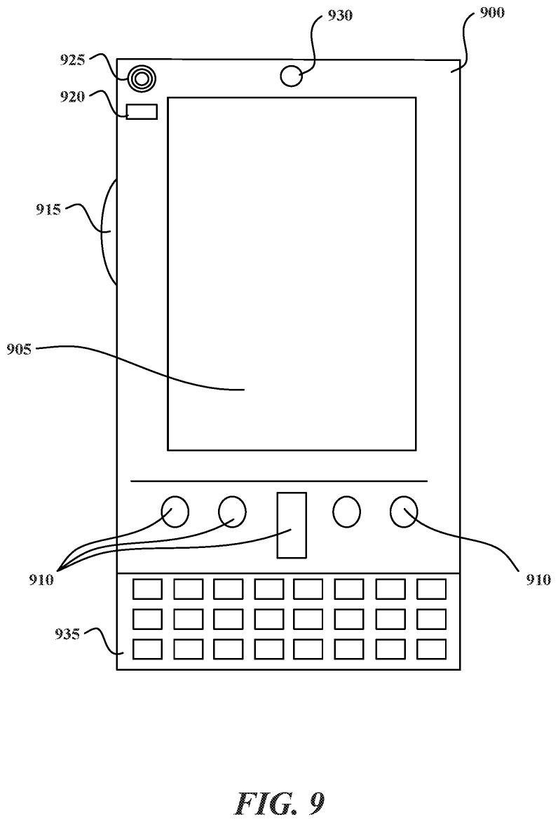

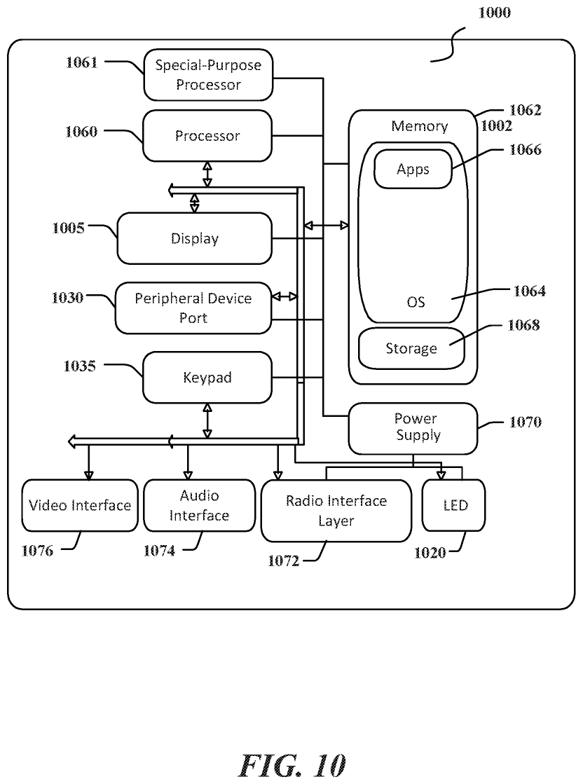

FIGS. 9 and 10 illustrate a mobile computing device 900, for example, a mobile telephone, a smart phone, wearable computer (such as smart eyeglasses), a tablet computer, an e-reader, a laptop computer, or other AR compatible computing device, with which embodiments of the disclosure may be practiced. With reference to FIG. 9, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative aspects, mobile computing device 900 may incorporate more or fewer input elements. For example, the display 905 may not be a touch screen in some embodiments. In yet another alternative embodiment, the mobile computing device 900 is a portable phone system, such as a cellular phone. The mobile computing device 900 may also include an optional keypad 935. Optional keypad 935 may be a physical keypad or a “soft” keypad generated on the touch screen display. In various embodiments, the output elements include the display 905 for showing a graphical user interface (GUI), a visual indicator 920 (e.g., a light emitting diode), and/or an audio transducer 925 (e.g., a speaker). In some aspects, the mobile computing device 900 incorporates a vibration transducer for providing the user with tactile feedback. In yet another aspect, the mobile computing device 900 incorporates input and/or output ports, such as an audio input (e.g., a microphone jack), an audio output (e.g., a headphone jack), and a video output (e.g., a HDMI port) for sending signals to or receiving signals from an external device.

FIG. 10 is a block diagram illustrating the architecture of one aspect of a mobile computing device. That is, the mobile computing device 1000 can incorporate a system (e.g., an architecture) 1002 to implement some aspects. In one embodiment, the system 1002 is implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000, including instructions for providing and operating a neuromorphic synchronization application.

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 920 may be used to provide visual notifications, and/or an audio interface 1074 may be used for producing audible notifications via the audio transducer 925. In the illustrated embodiment, the visual indicator 920 is a light emitting diode (LED) and the audio transducer 925 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 925, the audio interface 1074 may also be coupled to a microphone to receive audible input, such as to facilitate a telephone conversation. In accordance with embodiments of the present disclosure, the microphone may also serve as an audio sensor to facilitate control of notifications, as will be described below. The system 1002 may further include a video interface 1076 that enables an operation of an on-board camera 930 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10 by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio interface layer 1072 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

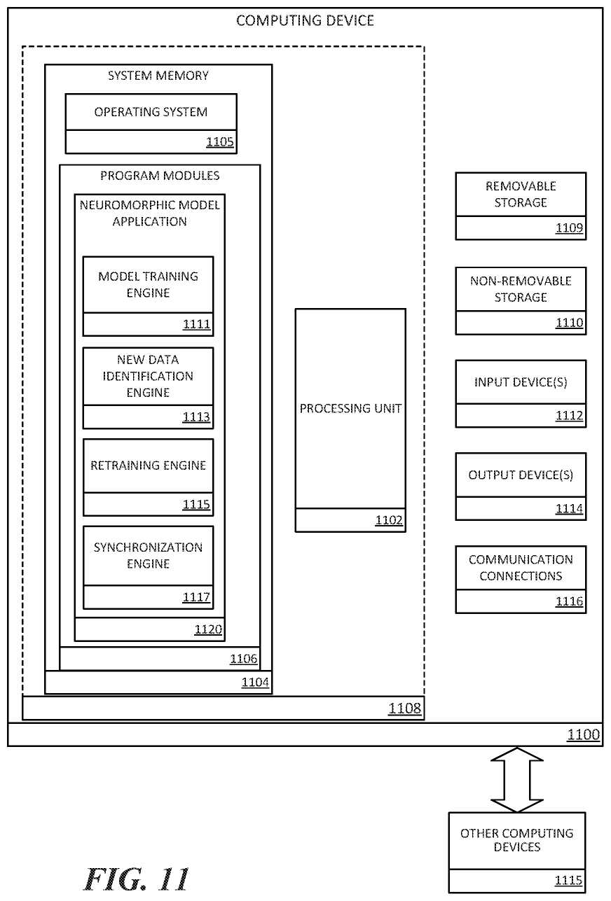

FIG. 11 is a block diagram illustrating physical components (e.g., hardware) of a computing device 1100 with which aspects of the disclosure may be practiced. The computing device components described below may have computer executable instructions for synchronizing neuromorphic models across devices and platforms. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 suitable for running one or more neuromorphic synchronization applications and/or services. The operating system 1105, for example, may be suitable for controlling the operation of the computing device 1100. Furthermore, embodiments of the disclosure may be practiced in conjunction with a graphics library, other operating systems, or any other application program and is not limited to any particular application or system. This basic configuration is illustrated in FIG. 11 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 11 by a removable storage device 1109 and a non-removable storage device 1110.

As stated above, a number of program modules and data files may be stored in the system memory 1104. While executing on the processing unit 1102, the program modules 1106 (e.g., neuromorphic model application 1120) may perform processes including, but not limited to, the aspects, as described herein. According to examples, model training engine 1111 may perform one or more operations associated with initially generating and training a neuromorphic model to perform a specific task. New data identification engine 1113 may perform one or more operations associated with identifying new data points from client devices for utilizing in retraining a neuromorphic model. Retraining engine 1115 may perform one or more operations associated with utilizing new datapoints from client devices to retrain a neuromorphic model. Synchronization engine 1117 may perform one or more operations associated with pushing a retrained neuromorphic model (or differences between a previously trained neuromorphic model and a retrained neuromorphic model) out to a plurality of client devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1100 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1100 may also have one or more input device(s) 1112 such as a keyboard, a mouse, a pen, a sound or voice input device, a touch or swipe input device, etc. The output device(s) 1114 such as a display, speakers, a printer, etc. may also be included. The aforementioned devices are examples and others may be used. The computing device 1100 may include one or more communication connections 1116 allowing communications with other computing devices 1150. Examples of suitable communication connections 1116 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

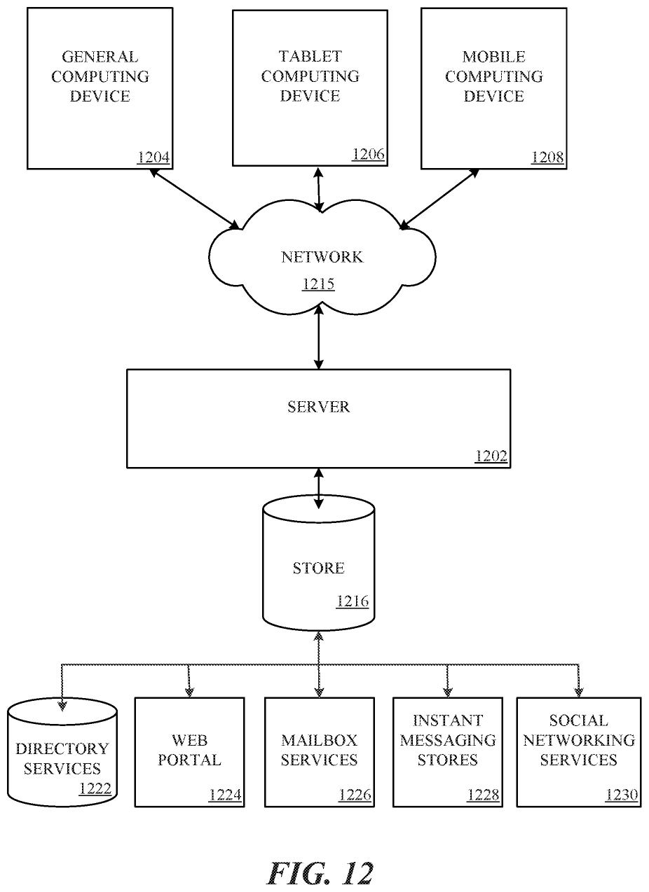

FIG. 12 illustrates one aspect of the architecture of a system for processing data received at a computing system from a remote source, such as a personal/general computer 1204, tablet computing device 1206, or mobile computing device 1208, as described above. Content displayed at server device 1202 may be stored in different communication channels or other storage types. For example, various documents may be stored using a directory service 1222, a web portal 1224, a mailbox service 1226, an instant messaging store 1228, or a social networking site 1230. The program modules 1106 may be employed by a client that communicates with server device 1202, and/or the program modules 1106 may be employed by server device 1202. The server device 1202 may provide data to and from a client computing device such as a personal/general computer 1204, a tablet computing device 1206 and/or a mobile computing device 1208 (e.g., a smart phone) through a network 1215. By way of example, the computer systems described herein may be embodied in a personal/general computer 1204, a tablet computing device 1206 and/or a mobile computing device 1208 (e.g., a smart phone). Any of these embodiments of the computing devices may obtain content from the store 1216, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer-implemented method for synchronizing neuromorphic models, the computer-implemented method comprising:
receiving, by a first neuromorphic model implemented on a neuromorphic architecture of a first computing device, a sensor input, wherein the neuromorphic model comprises a plurality of neurons, each of the plurality of neurons associated with:
a threshold value,
a weight value, and
a refractory period value;
processing the first sensor input by the first neuromorphic model;
determining a first output value based on the processing of the first sensor input;
modifying one of:
a threshold value of a neuron in the first neuromorphic model,
a weight value of the neuron in the first neuromorphic model, and
a refractory period value of the neuron in the first neuromorphic model;
saving, to the first computing device, a modified version of the first neuromorphic model based on the modification; and
sending an update comprising the modification to a second computing device hosting the first neuromorphic model.

2. The computer-implemented method of claim 1, wherein the modification of one of:
the threshold value, the weight value, and the refractory period value is based on:
determining that the first output value is an incorrect output value;

3. The computer-implemented method of claim 2, wherein the value that is modified is identified based on application of a genetic algorithm to a plurality of versions of the first neuromorphic model.

4. The computer-implemented method of claim 1, further comprising, prior to sending the update:
processing a second sensor input by the modified version of the first neuromorphic model;
determining a second output value based on the processing of the second sensor input; and
determining that the first output value is a correct output value;

5. The computer-implemented method of claim 1, further comprising:
modifying, by the second computing device, a corresponding one of:
the threshold value of the neuron in the first neuromorphic model the second computing device hosts;
the weight value of the neuron in the first neuromorphic model the second computing device hosts; and
the refractory period value of the neuron in the first neuromorphic model the second computing device hosts.

6. The computer-implemented method of claim 1, wherein the neuromorphic architecture of the first computing device is a neuromorphic hardware architecture, and wherein saving the modified version of the first neuromorphic model based on the modification comprises modifying the neuromorphic hardware architecture.

7. The computer-implemented method of claim 6, further comprising:
generating a software model corresponding to the modified neuromorphic hardware architecture.

8. The computer-implemented method of claim 7, wherein the update that is sent to the second computing device comprises a portion of the software model corresponding to one of:
the threshold value of the neuron in the first neuromorphic model that was modified,
the weight value of the neuron in the first neuromorphic model that was modified, and
the refractory period value of the neuron in the first neuromorphic model that was modified.

9. The computer-implemented method of claim 1, wherein the neuromorphic architecture of the first computing device is a software architecture and the first neuromorphic model is executed as software by the first device.

10. The computer-implemented method of claim 1, wherein the neuromorphic model comprises a spiking neural network.

11. A system for synchronizing neuromorphic models, comprising:
a memory for storing executable program code; and
one or more processors, functionally coupled to the memory, the one or more processors being responsive to computer-executable instructions contained in the program code and operative to:
maintain, by a first computing device, a first version of a neuromorphic model that has been trained on a first dataset, the first version of the neuromorphic model comprising a plurality of neurons, each of the plurality of neurons associated with a plurality of parameters, the plurality of parameters comprising:
a threshold value,
a weight value, and
a refractory period value;
receive an update to the first dataset;
retrain the first version of the neuromorphic model on the updated dataset, the retraining comprising modifying a value of one of the parameters of the first version of the neuromorphic model;
save the retrained first version of the neuromorphic model as a second version of the neuromorphic model;
identify a second computing device that includes the first version of the neuromorphic model; and
send an update to the second computing device comprising the modified value of one of the parameters.

12. The system of claim 11, wherein in retraining the first version of the neuromorphic model, the one or more processors are further responsive to the computer-executable instructions contained in the program code and operative to:
apply a genetic algorithm to the first version of the neuromorphic model and the updated dataset.

13. The system of claim 11, wherein the update to the first dataset is received from the second computing device, and wherein the update to the first dataset comprises at least one of:
an update to a value of a datapoint of the first dataset;
an addition of a new datapoint to the first dataset; and
a deletion of a datapoint of the first dataset.

14. The system of claim 11, wherein the first computing device comprises a host computing device and the second computing device comprises a remote computing device connected to the host computing device.

15. The system of claim 11, wherein the one or more processors are further responsive to the computer-executable instructions contained in the program code an operative to:
save the second version of the neuromorphic model to a hardware neuromorphic architecture of the first computing device; and
generate the second version of the neuromorphic model in software.

16. A computer-readable storage device comprising executable instructions that, when executed by one or more processors, assists with synchronizing neuromorphic models, the computer-readable storage device including instructions executable by the one or more processors for:
maintaining, by a first computing device, a first version of a neuromorphic model that has been trained on a first dataset, the first version of the neuromorphic model comprising a plurality of neurons, each of the plurality of neurons associated with a plurality of parameters, the plurality of parameters comprising:
a threshold value,
a weight value, and
a refractory period value;
modifying the first dataset;
sending the modification of the first dataset to a service hosting the first version of the neuromorphic model in a cloud-based infrastructure; and
receiving, from the service, an update to the first version of the neuromorphic model.

17. The computer-readable storage device of claim 16, wherein the instructions are further executable by the one or more processors for generating the first version of the neuromorphic model, the generating comprising:
generating a first plurality of neuromorphic models; and
applying a genetic algorithm to the plurality of neuromorphic models and the first dataset.

18. The computer-readable storage device of claim 16 wherein the neuromorphic model is a spiking neural network.

19. The computer-readable storage device of claim 16, wherein the update to the first version of the neuromorphic model comprises a modification to at least one of:
a threshold value associated with a neuron of the first version of the neuromorphic model;
a weight value associated with a neuron of the first version of the neuromorphic model; and
a refractory period value associated with a neuron of the first version of the neuromorphic model.

20. The computer-readable storage device of claim 19, wherein the instructions are further executable by the one or more processors for:
modifying the first neuromorphic model based on the received update; and
saving the modified neuromorphic model.
